(19) United States
(12) Patent Application Publication
(10) Pub. No.: US 2026/0269919 A1
(43) Pub. Date: Sep. 10, 2026

(54) METHOD AND APPARATUS FOR BEAM MANAGEMENT IN MOBILE COMMUNICATIONS

(71) Applicant: MEDIATEK INC., Hsinchu City (TW)

(72) Inventors: Chien-Hwa HWANG, Hsinchu City (TW); Chia-Hao YU, Hsinchu City (TW); Hsuan-Yi WU, Hsinchu City (TW); Tsung-Wei CHIANG, Hsinchu City (TW); Jiann-Ching GUEY, Hsinchu City (TW)

(21) Appl. No.: 19/166,204

(22) PCT Filed: Jun. 5, 2024
(86) PCT No.: PCT/CN2024/097465

§ 371 Date: Sep. 17, 2025

Related U.S. Application Data
(60) Provisional application No. 63/506,388, filed on Jun. 6, 2023.
(60) Provisional application No. 63/592,603, filed on Oct. 24, 2023.

(51) Int. Cl. H04B 7/06; H04B 7/0456

(52) U.S. Cl. CPC H04B 7/06952; H04B 7/0456

(57) ABSTRACT

Examples pertaining to procedures of determining beamforming parameters are described. A user equipment (UE) receives a first pilot signal from a network node and determines a radio frequency (RF) signature associated with a dominant path of a first channel between the network node and the apparatus according to the first pilot signal. The UE reports the RF signature associated with the dominant path of the first channel to the network node. Then, the UE receives a second pilot signal from the network node and determines at least one channel parameter associated with a second channel according to the second pilot signal. The UE reports the channel parameter associated with the second channel to the network node.

### CROSS REFERENCE TO RELATED PATENT APPLICATION(S)

The present disclosure is part of a non-provisional application claiming the priority benefit of U.S. Patent Application No. 63/506,388, filed 6 Jun. 2023 and U.S. Patent Application No. 63/592,603, filed 24 Oct. 2023, the contents of which herein being incorporated by reference in their entirety.

### TECHNICAL FIELD

The present disclosure is generally related to beam management in mobile communications and, more particularly, to procedures of determining beamforming parameters for beam management.

### BACKGROUND

Unless otherwise indicated herein, approaches described in this section are not prior art to the claims listed below and are not admitted as prior art by inclusion in this section.

Massive multiple-input multiple-output (MIMO) technology has been introduced in 5th Generation (5G), New Radio (NR). The massive MIMO is a wireless transmission technology using massive antennas in a network node or a base station (BS) (such as a next generation Node B (gNB)). To improve the performance of massive MIMO, a hybrid beamforming architecture has been adopted.

Hybrid beamforming is a combination of analog and digital beamforming. The basic idea of analog beamforming is to use phase shifters to control the phase of each transmitted signal. Analog beamforming affects the beam direction of the antenna array, thereby improving coverage. The basic idea of digital beamforming is to use a digital precoder before radio frequency (RF) up conversion at transmission (Tx) or after down conversion at reception (Rx) in order to decide the proper multiplexing and phase shifting.

In such architecture, the precoding is performed in the digital domain and the antenna elements are driven by analog phase shifters. Comparing to the legacy designs, hybrid beamforming significantly reduces the number of RF chains and results in less cost, less computational load and less power consumption.

Since hybrid beamforming is an efficient solution for 5G NR, how to determine the parameters associated with analog beamforming and digital precoding becomes an important issue for the newly developed wireless communication network. Therefore, there is a need to provide proper schemes or procedures of determining beamforming parameters for beam management.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to procedures of determining beamforming parameters for beam management in mobile communications.

In one aspect, a method may involve an apparatus receiving a pilot signal from a network node, determining a radio frequency (RF) signature associated with a dominant path of a channel between the network node and the apparatus according to the pilot signal and reporting the RF signature associated with the dominant path of the channel to the network node.

In one aspect, an apparatus may involve a transceiver which, during operation, wirelessly communicates with at least one network node. The apparatus may also involve a processor communicatively coupled to the transceiver such that, during operation, the processor performs following operations: receiving, via the transceiver, a pilot signal from the network node, determining a radio frequency (RF) signature associated with a dominant path of a channel between the network node and the apparatus according to the pilot signal, and reporting, via the transceiver, the RF signature associated with the dominant path of the channel to the network node. The RF signature comprises information regarding at least one of an angle of departure, a fading coefficient and a delay of the dominant path. The pilot signal comprises a non-beamformed pilot signal and the channel comprises a non-beamformed channel.

In one aspect, a method may involve a network node receiving a radio frequency (RF) signature associated with a dominant path of a first channel between the network node and a communication apparatus from the communication apparatus and determining one or more parameters of a beamformer based on the RF signature associated with the dominant path of the first channel.

In one aspect, a method may involve an apparatus receiving a first pilot signal from a network node and determining a radio frequency (RF) signature associated with a dominant path of a first channel between the network node and the apparatus according to the first pilot signal. The method may also involve the apparatus reporting the RF signature associated with the dominant path of the first channel to the network node. The method may further involve the apparatus receiving a second pilot signal from the network node, determining at least one channel parameter associated with a second channel according to the second pilot signal and reporting the channel parameter associated with the second channel to the network node.

In one aspect, a method may involve a network node transmitting a first pilot signal to a communication apparatus and receiving a radio frequency (RF) signature associated with a dominant path of a first channel between the network node and the communication apparatus from the communication apparatus. The RF signature associated with the dominant path of the first channel is determined based on the first pilot signal. The method may also involve the network node determining one or more parameters of a beamformer based on the RF signature associated with the dominant path of the first channel. The method may further involve the network node transmitting a second pilot signal to the communication apparatus and receiving at least one channel parameter associated with a second channel from the communication apparatus.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a diagram depicting an example scenario under schemes in accordance with implementations of the present disclosure.

FIG. 4 is a diagram depicting an example scenario under schemes in accordance with implementations of the present disclosure.

FIG. 5 is a diagram depicting an example scenario under schemes in accordance with implementations of the present disclosure.

FIG. 6 is a diagram depicting an example scenario under schemes in accordance with implementations of the present disclosure.

FIG. 7 is a diagram depicting an example communication system in accordance with an implementation of the present disclosure.

FIG. 8 is a diagram depicting an example process in accordance with an implementation of the present disclosure.

FIG. 9 is a diagram depicting an example process in accordance with an implementation of the present disclosure.

FIG. 10 is a diagram depicting an example process in accordance with an implementation of the present disclosure.

FIG. 11 is a diagram depicting an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to procedures of determining beamforming parameters for beam management in mobile communications. According to the present disclosure, a number of possible solutions may be implemented separately or jointly. That is, although these possible solutions may be described below separately, two or more of these possible solutions may be implemented in one combination or another.

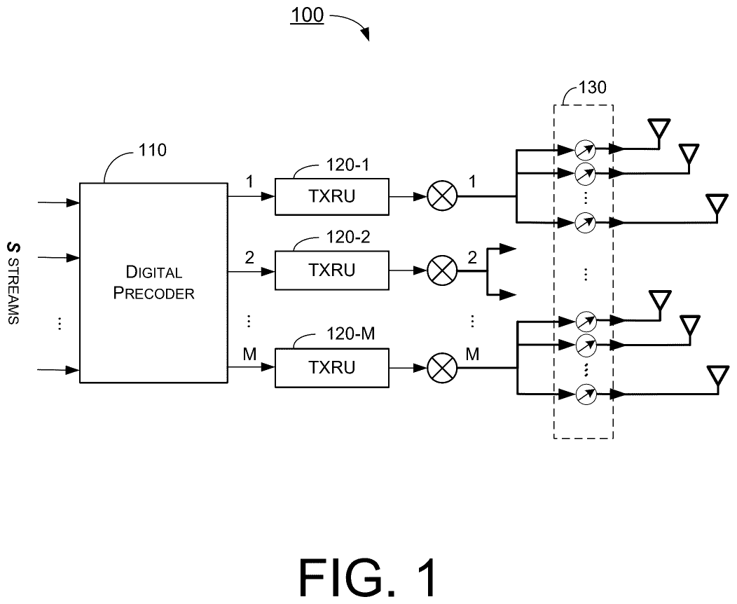

FIG. 1 illustrates an example scenario 100 under schemes in accordance with implementations of the present disclosure. Scenario 100 illustrates an exemplary beamforming architecture of a network apparatus (e.g., a network node, a BS or a gNB). In some implementations, the network node may have a hybrid beamforming architecture, that is, comprising a digital precoder 110 and an array beamformer 130.

The digital precoder 110 performs precoding on S streams and provides the pre-coded streams or signals to a plurality of transmit radio units (TXRUs).

The plurality of TXRUs may comprise TXRU 120-1, TXRU 120-2, . . . TXRU 120-M, where S and M are positive integers.

The array beamformer 130 may be an analog beamformer and may comprise a plurality of phase shifters each being configured to adjust a phase of a signal provided thereto before the signal is transmitted by an antenna element or an antenna array. With the array beamformer 130, one or more beamformed signals can be transmitted by the network node via the associated antenna elements or the associated antenna array.

In some implementations, an antenna element may be an antenna port or a physical antenna of the network node. In addition, in some implementations, an antenna port may be associated with one or more physical antennas of the network node.

To achieve efficient and accurate beam management, several procedures of determining beamforming parameters, including the parameters associated with the analog beamformer (e.g., the array beamformer 130) and the parameters associated with the digital precoder (e.g., the digital precoder 110), are proposed.

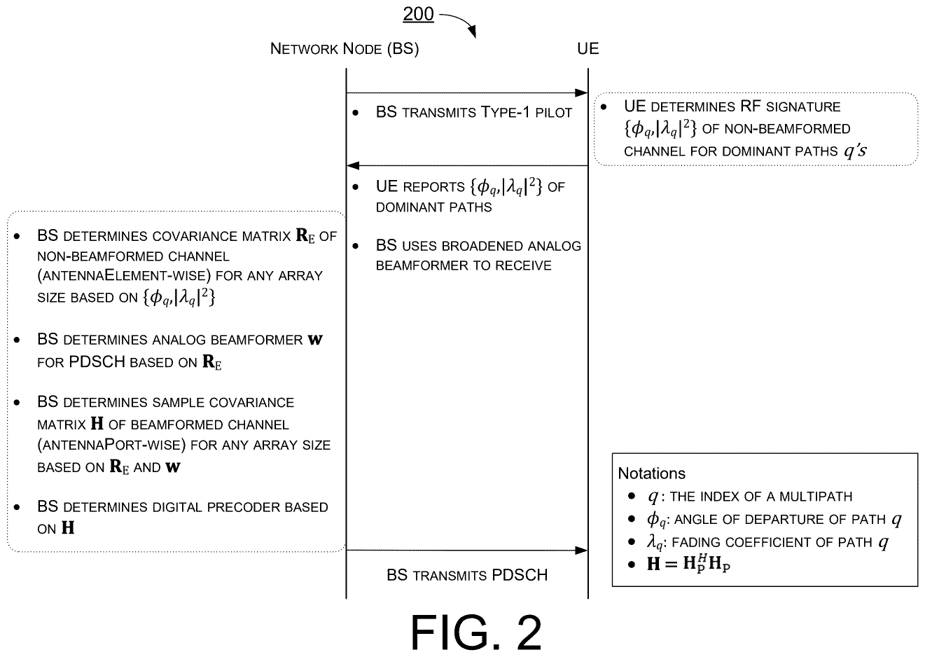

FIG. 2 illustrates an example scenario 200 under schemes in accordance with implementations of the present disclosure. Scenario 200 illustrates an exemplary procedure of determining one or more parameters of the analog beamformer and one or more parameters of the digital precoder based on a first method of the present disclosure.

In some implementations, the network node (e.g., the BS) may transmit a pilot signal to the communication apparatus (e.g., a user equipment (UE)). In some implementations, the pilot signal may be a Type-1 pilot, and the Type-1 pilot may be or may comprise a non-beamformed pilot signal. In some implementations, the non-beamformed pilot signal may be the pilot signal that has not undergone beamforming processing.

In some implementations, the UE may receive the pilot signal from the BS and determine (or estimate) a radio frequency (RF) signature associated with a dominant path of a channel between the BS and the UE according to the pilot signal. In some implementations, the channel may comprise a non-beamformed channel. In addition, in some implementations, the RF signature may comprise parameters {φ_{q}, |λ_{q}|²}, where q represents the index of a multipath, φ_{q} represents an angle of departure of the path q and λ_{q} represents the fading coefficient of the path q.

In some implementations, the UE may report the RF signature {φ_{q}, |λ_{q}|²} associated with the dominant path of the channel to the BS. The BS may use a broadened analog beamformer to receive the RF signature reported by the UE.

In some implementations, upon receiving the RF signature, the BS may determine one or more parameters of the analog beamformer and one or more parameters of the digital precoder. Specifically, in some implementations, the BS may determine or compute a covariance matrix R_{E} of the non-beamformed channel (e.g., antenna-element-wise) for any array size based on the RF signature {φ_{q}, |λ_{q}|²}.

In some implementations, the BS may determine the analog beamformer w for physical downlink shared channel (PDSCH) based on the covariance matrix R_{E}. In some implementations, the analog beamformer w may be obtained based on the non-beamformed covariance matrix R_{E} by eigenvalue decomposition (e.g., R_{E}=UAU^{H}, where w is the column of U corresponding to the largest eigenvalue).

In some implementations, the BS may further determine sample covariance matrix H of a beamformed channel (e.g., antenna-port-wise) for any array size based on the covariance matrix R_{E} and the analog beamformer w, where

$$H = {H}_{P}^{H} {H}_{P}$$

and the superscript H denotes the Hermitian.

Specially, in some implementations, by means of the analog beamformer w, the BS may obtain an analog beamforming matrix B, where the columns of the matrix B may be formed by w. In some implementations, the beamformed channel matrix may be given as H_{P}=H_{E}B, where H_{E} represents the non-beamformed channel matrix. With the covariance matrix R_{E} and the analog beamformer w, the sample covariance matrix of the beamformed channel may be obtained as

$${H}_{P}^{H} {H}_{P} = {( {H}_{E} B )}^{H} ( {H}_{E} B ) = {B}^{H} {R}_{E} B .$$

In some implementations, the BS may further determine the digital precoder based on the sample covariance matrix H of the beamformed channel. In some implementations, have the parameters of the analog beamformer w and the parameters of the digital precoder been determined, the BS may transmit a downlink signal which has been precoded by the digital precoder and beamformed by the analog beamformer on PDSCH to the UE.

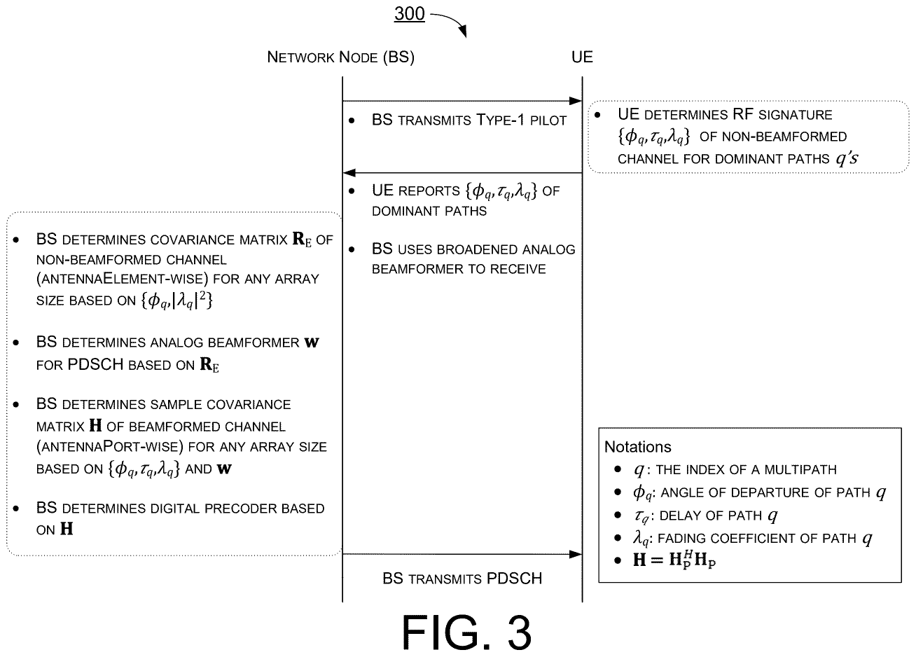

FIG. 3 illustrates an example scenario 300 under schemes in accordance with implementations of the present disclosure. Scenario 300 illustrates an exemplary procedure of determining one or more parameters of the analog beamformer and one or more parameters of the digital precoder based on a second method of the present disclosure.

In some implementations, the network node (e.g., the BS) may transmit a pilot signal to the communication apparatus (e.g., the UE). In some implementations, the pilot signal may be a Type-1 pilot, and the Type-1 pilot may be or may comprise a non-beamformed pilot signal. In some implementations, the non-beamformed pilot signal may be the pilot signal that has not undergone beamforming processing.

In some implementations, the UE may receive the pilot signal from the BS and determine (or estimate) an RF signature associated with a dominant path of a channel between the BS and the UE according to the pilot signal. In some implementations, the channel may comprise a non-beamformed channel. In addition, in some implementations, the RF signature may comprise parameters {φ_{q}, τ_{q}, λ_{q}}, where τ_{q} represents the delay of the path q.

In some implementations, the UE may report the RF signature {φ_{q}, τ_{q}, λ_{q}} associated with the dominant path of the channel to the BS. The BS may use a broadened analog beamformer to receive the RF signature reported by the UE.

In some implementations, upon receiving the RF signature, the BS may determine one or more parameters of the analog beamformer and one or more parameters of the digital precoder. Specifically, in some implementations, the BS may determine or compute a covariance matrix R_{E} of the non-beamformed channel (e.g., antenna-element-wise) for any array size based on the parameters {φ_{q}, |λ_{q}|²}. In some implementations, the BS may determine the analog beamformer w for PDSCH based on the covariance matrix R_{E}. In some implementations, the analog beamformer w may be obtained based on the non-beamformed covariance matrix R_{E} by eigenvalue decomposition as introduced above.

In some implementations, the BS may determine sample covariance matrix H

$$( H = {H}_{P}^{H} {H}_{P} )$$

of a beamformed channel (e.g., antenna-port-wise) for any array size based on the RF signature {φ_{q}, τ_{q}, λ_{q}} and the analog beamformer w.

In some implementations, the BS may determine the digital precoder based on the sample covariance matrix H of the beamformed channel. In some implementations, have the parameters of the analog beamformer w and the parameters of the digital precoder been determined, the BS may transmit a downlink signal which has been precoded by the digital precoder and beamformed by the analog beamformer on PDSCH to the UE.

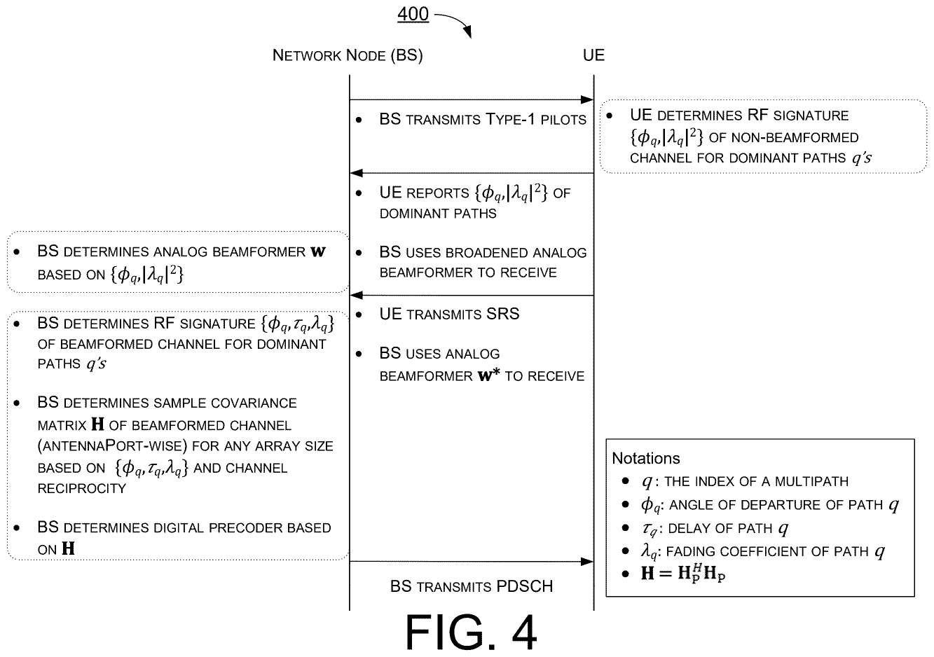

FIG. 4 illustrates an example scenario 400 under schemes in accordance with implementations of the present disclosure. Scenario 400 illustrates an exemplary procedure of determining one or more parameters of the analog beamformer and one or more parameters of the digital precoder based on a third method of the present disclosure.

In some implementations, the network node (e.g., the BS) may transmit a pilot signal to the communication apparatus (e.g., the UE). In some implementations, the pilot signal may be a Type-1 pilot, and the Type-1 pilot may be or may comprise a non-beamformed pilot signal, such as a non-beamformed channel state information reference signal (CSI-RS). In some implementations, the non-beamformed pilot signal may be the pilot signal that has not undergone beamforming processing.

In some implementations, the UE may receive the pilot signal from the BS and determine (or estimate) an RF signature associated with a dominant path of a channel between the BS and the UE according to the pilot signal. In some implementations, the channel may comprise a non-beamformed channel. In addition, in some implementations, the RF signature may comprise parameters {φ_{q}, |λ_{q}|²}.

In some implementations, the UE may report the RF signature {φ_{q}, |λ_{q}|²} associated with the dominant path of the channel to the BS. The BS may use a broadened analog beamformer to receive the RF signature reported by the UE.

In some implementations, upon receiving the RF signature, the BS may determine one or more parameters of the analog beamformer and one or more parameters of the digital precoder. Specifically, in some implementations, the BS may determine the analog beamformer w based on the RF signature {φ_{q}, |λ_{q}|²} as introduced above.

In some implementations, the UE may further transmit a reference signal, such as a sounding reference signal (SRS), to the BS, for the BS to determine one or more parameters of the precoder. The BS may use the analog beamformer w* to receive, wherein the analog beamformer w* may be derived from the analog beamformer w, and wherein the analog beamformer w* and the analog beamformer w may be different in the direction. For example, the analog beamformer w may be applied in a direction of transmitting a signal to the UE and the analog beamformer w* may be applied in a direction of receiving a signal from the UE.

In some implementations, upon receiving the reference signal, the BS may determine (or estimate) the RF signature {φ_{q}, τ_{q}, λ_{q}} associated with a dominant path of a channel between the BS and the UE according to the reference signal. In some implementations, the channel may comprise a beamformed channel.

In some implementations, the BS may determine sample covariance matrix H

$$( H = {H}_{P}^{H} {H}_{P} )$$

of the beamformed channel (e.g., antenna-port-wise) for any array size based on the RF signature {φ_{q}, τ_{q}, λ_{q}} and the channel reciprocity.

In some implementations, the BS may determine the digital precoder based on the sample covariance matrix H of the beamformed channel. In some implementations, have the parameters of the analog beamformer w and the parameters of the digital precoder been determined, the BS may transmit a downlink signal which has been precoded by the digital precoder and beamformed by the analog beamformer on PDSCH to the UE.

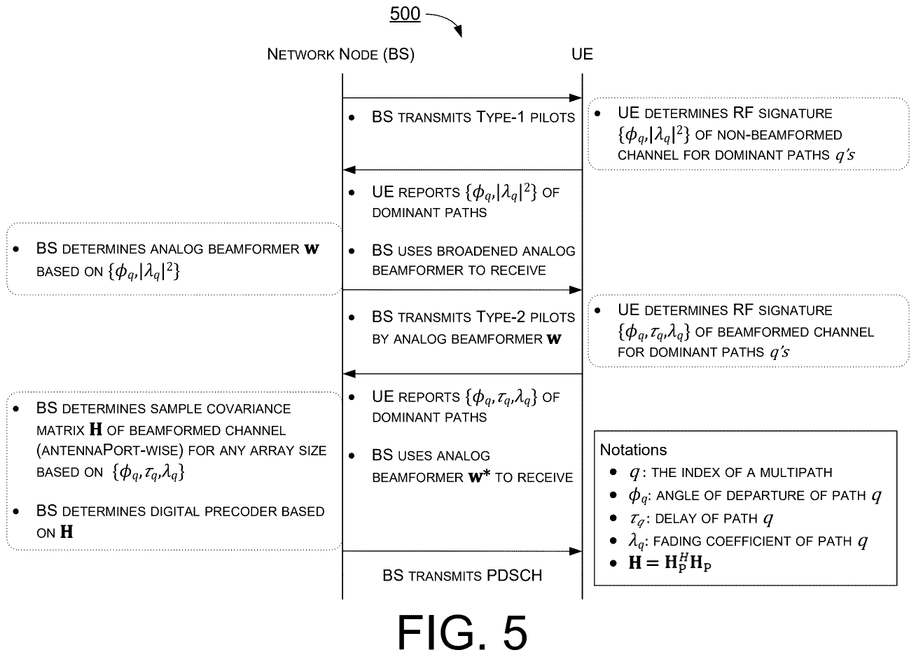

FIG. 5 illustrates an example scenario 500 under schemes in accordance with implementations of the present disclosure. Scenario 500 illustrates an exemplary procedure of determining one or more parameters of the analog beamformer and one or more parameters of the digital precoder based on a fourth method of the present disclosure.

In some implementations, the network node (e.g., the BS) may transmit a first pilot signal to the communication apparatus (e.g., the UE). In some implementations, the first pilot signal may be a Type-1 pilot, and the Type-1 pilot may be or may comprise a non-beamformed pilot signal. In some implementations, the non-beamformed pilot signal may be the pilot signal that has not undergone beamforming processing.

In some implementations, the UE may receive the first pilot signal from the BS and determine (or estimate) an RF signature associated with a dominant path of a first channel between the BS and the UE according to the first pilot signal. In some implementations, the first channel may comprise a non-beamformed channel. In addition, in some implementations, the RF signature may comprise parameters {φ_{q}, |λ_{q}|²}.

In some implementations, the UE may report the RF signature {φ_{q}, |λ_{q}|²}, associated with the dominant path of the first channel to the BS. The BS may use a broadened analog beamformer to receive the RF signature reported by the UE.

In some implementations, upon receiving the RF signature, the BS may determine the analog beamformer w based on the RF signature {φ_{q}, |λ_{q}|²} as introduced above.

In some implementations, the BS may further transmit a second pilot signal to the UE by using the analog beamformer w. In some implementations, the second pilot signal may be a Type-2 pilot, and the Type-2 pilot may be or may comprise a beamformed pilot signal, such as a beamformed CSI-RS. In some implementations, the beamformed pilot signal may be the pilot signal that has been beamformed by the beamformer.

In some implementations, the UE may receive the second pilot signal from the BS and determine (or estimate) channel parameters of a second channel between the BS and the UE, such as an RF signature associated with a dominant path of the second channel according to the second pilot signal. In some implementations, the second channel may comprise a beamformed channel. In addition, in some implementations, the RF signature may comprise parameters {φ_{q}, τ_{q}, λ_{q}}.

In some implementations, the UE may report the RF signature {φ_{q}, τ_{q}, λ_{q}} associated with the dominant path of the second channel to the BS. The BS may use the analog beamformer w* to receive the RF signature reported by the UE, where the analog beamformer w* may be derived from the analog beamformer w, and the analog beamformer w* and the analog beamformer w may be different in the direction.

In some implementations, upon receiving the RF signature, the BS may determine the sample covariance matrix H

$$( H = {H}_{P}^{H} {H}_{P} )$$

of the beamformed channel (e.g., antenna-port-wise) for any array size based on the RF signature {φ_{q}, τ_{q}, λ_{q}}.

In some implementations, the BS may determine the digital precoder based on the sample covariance matrix H of the beamformed channel. In some implementations, have the parameters of the analog beamformer w and the parameters of the digital precoder been determined, the BS may transmit a downlink signal which has been precoded by the digital precoder and beamformed by the analog beamformer on PDSCH to the UE.

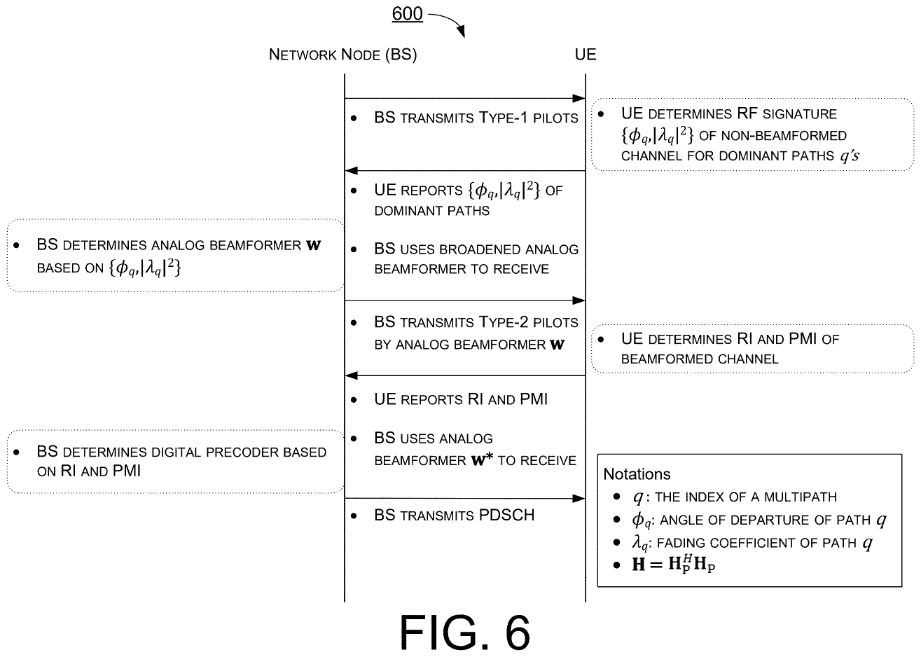

FIG. 6 illustrates an example scenario 600 under schemes in accordance with implementations of the present disclosure. Scenario 600 illustrates an exemplary procedure of determining one or more parameters of the analog beamformer and one or more parameters of the digital precoder based on a fifth method of the present disclosure.

In some implementations, the network node (e.g., the BS) may transmit a first pilot signal to the communication apparatus (e.g., the UE). In some implementations, the first pilot signal may be a Type-1 pilot, and the Type-1 pilot may be or may comprise a non-beamformed pilot signal. In some implementations, the non-beamformed pilot signal may be the pilot signal that has not undergone beamforming processing.

In some implementations, the UE may receive the first pilot signal from the BS and determine (or estimate) an RF signature associated with a dominant path of a first channel between the BS and the UE according to the first pilot signal. In some implementations, the first channel may comprise a non-beamformed channel. In addition, in some implementations, the RF signature may comprise parameters {φ_{q}, |λ_{q}|²}.

In some implementations, the UE may report the RF signature {φ_{q}, |λ_{q}|²} associated with the dominant path of the first channel to the BS. The BS may use a broadened analog beamformer to receive the RF signature reported by the UE.

In some implementations, upon receiving the RF signature, the BS may determine the analog beamformer w based on the RF signature {φ_{q}, |λ_{q}|²} as introduced above.

In some implementations, the BS may further transmit a second pilot signal to the UE by using the analog beamformer w. In some implementations, the second pilot signal may be a Type-2 pilot, and the Type-2 pilot may be or may comprise a beamformed pilot signal. In some implementations, the beamformed pilot signal may be the pilot signal that has been beamformed by the beamformer.

In some implementations, the UE may receive the second pilot signal from the BS and determine (or estimate) channel parameters of a second channel between the BS and the UE according to the second pilot signal. In some implementations, the second channel may comprise a beamformed channel. In some implementations, the channel parameters may comprise at least one of a rank indicator (RI) and a precoding matrix indicator (PMI).

In some implementations, the UE may report the RI and PMI of the second channel to the BS. The BS may use the analog beamformer w* to receive the RI and PMI reported by the UE, as introduced above.

In some implementations, upon receiving the RI and PMI, the BS may determine the digital precoder based on the RI and PMI. In some implementations, have the parameters of the analog beamformer w and the parameters of the digital precoder been determined, the BS may transmit a downlink signal which has been precoded by the digital precoder and beamformed by the analog beamformer on PDSCH to the UE.

In a first aspect of the present disclosure, the network node may transmit at least the non-beamformed pilot signal in the procedure of determining beamforming parameters, as illustrated in FIG. 2, FIG. 3 and FIG. 4. In a second aspect of the present disclosure, the network node may sequentially transmit the non-beamformed pilot signal and the beamformed pilot signal in the procedure of determining beamforming parameters, as illustrated in FIG. 5 and FIG. 6.

With respect to the operations of the communication apparatus (e.g., the UE) in the first aspect of the present disclosure, the UE may receive a pilot signal from a network node and determine an RF signature associated with a dominant path of a channel between the network node and the UE according to the pilot signal. The UE may further report the RF signature associated with the dominant path of the channel to the network node.

In some implementations, the RF signature may comprise information regarding an angle of departure and a fading coefficient of the dominant path.

In some implementations, the RF signature may further comprise information regarding a delay of the dominant path.

In some implementations, the pilot signal may comprise a non-beamformed pilot signal, and the channel may comprise a non-beamformed channel.

In some implementations, the dominant path of the channel may comprise a path between the network node and the UE (e.g., a path from the antenna array of the network node to the antenna array of the UE) with a received signal power greater than a predetermined threshold.

In some implementations, the UE may further receive a downlink signal from the network node. The downlink signal may be precoded by a precoder and beamformed by a beamformer of the network node and the RF signature reported by the UE may be used to determine one or more parameters of the precoder and one or more parameters of the beamformer.

In some implementations, the UE may transmit a reference signal to the network node and receive a downlink signal from the network node. In some implementations, downlink signal may be precoded by a precoder and beamformed by a beamformer of the network node and the RF signature reported by the UE may be used to determine one or more parameters of the precoder and the reference signal may be used to determine one or more parameters of the precoder.

With respect to the operations of the network node in the first aspect of the present disclosure, the network node may receive an RF signature associated with a dominant path of a first channel between the network node and a communication apparatus from the communication apparatus and determine one or more parameters of a beamformer based on the RF signature associated with the dominant path of the first channel.

In some implementations, the RF signature associated with the dominant path of the first channel may comprise information regarding an angle of departure and a fading coefficient of the dominant path of the first channel.

In some implementations, the RF signature associated with the dominant path of the first channel may further comprise information regarding a delay of the dominant path of the first channel.

In some implementations, the dominant path of the first channel may comprise a path between the network node and the communication apparatus (e.g., a path from the antenna array of the network node to the antenna array of the communication apparatus) with a received signal power greater than a predetermined threshold.

In some implementations, in the determining of the one or more parameters of the beamformer, the network node may determine a covariance matrix of the first channel based on the RF signature associated with the dominant path of the first channel and determine the one or more parameters of the beamformer based on the covariance matrix of the first channel.

In some implementations, the network node may further determine a covariance matrix of a second channel between the network node and the communication apparatus based on the covariance matrix of the first channel and the one or more parameters of the beamformer or based on the RF signature associated with the dominant path of the first channel and the one or more parameters of the beamformer, and determine one or more parameters of a precoder based on the covariance matrix of the second channel.

In some implementations, the network node may receive a reference signal from the communication apparatus and determine an RF signature associated with a dominant path of a second channel between the communication apparatus and the network node according to the reference signal.

In some implementations, the first channel may comprise a non-beamformed channel and the second channel may comprise a beamformed channel.

In some implementations, the network node may determine a covariance matrix of the second channel based on the RF signature associated with the dominant path of the second channel and channel reciprocity and determine one or more parameters of a precoder based on the covariance matrix of the second channel.

In some implementations, the RF signature associated with the dominant path of the second channel may comprise information regarding an angle of departure, a fading coefficient and a delay of the dominant path of the second channel, and the dominant path of the second channel may comprise a path between the beamformer (e.g., an input of the beamformer) of the network node and the communication apparatus with a received signal power greater than a predetermined threshold.

In some implementations, the dominant path of the second channel may comprise a path from the input of the beamformer of the network node to the communication apparatus with a received signal power greater than a predetermined threshold and/or comprise a path from the communication apparatus to the beamformer of the network node with a received signal power greater than a predetermined threshold.

In some implementations, the network node may transmit a pilot signal to the communication apparatus. In some implementations, the pilot signal may comprise a non-beamformed pilot signal and the RF signature associated with the dominant path of the first channel may be determined based on the pilot signal.

With respect to the operations of the communication apparatus (e.g., the UE) in the second aspect of the present disclosure, the UE may receive a first pilot signal from a network node and determine an RF signature associated with a dominant path of a first channel between the network node and the apparatus according to the first pilot signal. The UE may also report the RF signature associated with the dominant path of the first channel to the network node and receive a second pilot signal from the network node. The UE may further determine at least one channel parameter associated with a second channel according to the second pilot signal and report the channel parameter associated with the second channel to the network node.

In some implementations, the RF signature associated with the dominant path of the first channel may comprise information regarding an angle of departure and a fading coefficient of the dominant path of the first channel.

In some implementations, the first pilot signal may comprise a non-beamformed pilot signal, and the first channel may comprise a non-beamformed channel.

In some implementations, the dominant path of the first channel may comprise a path between the network node and the apparatus (e.g., a path from the antenna array of the network node to the antenna array of the apparatus) with a received signal power greater than a predetermined threshold.

In some implementations, the second pilot signal may comprise a beamformed pilot signal generated by a beamformer of the network node, and the RF signature associated with the dominant path of the first channel may be used to determine one or more parameters of the beamformer.

In some implementations, the channel parameter may comprise an RF signature associated with a dominant path of the second channel, and the second channel may comprise a beamformed channel.

In some implementations, the UE may receive a downlink signal from the network node. In some implementations, the downlink signal may be precoded by a precoder and beamformed by the beamformer of the network node and the RF signature associated with the dominant path of the second channel may be used to determine one or more parameters of the precoder.

In some implementations, the second pilot signal may comprise a beamformed pilot signal generated by a beamformer of the network node and the second channel may comprise a beamformed channel. In some implementations, the channel parameter may comprise at least one of an RI and a PMI.

In some implementations, the UE may receive a downlink signal from the network node. In some implementations, the downlink signal may be precoded by a precoder and beamformed by the beamformer of the network node and the channel parameter may be used to determine one or more parameters of the precoder.

With respect to the operations of the network node in the second aspect of the present disclosure, the network node may transmit a first pilot signal to a communication apparatus and receive an RF signature associated with a dominant path of a first channel between the network node and the communication apparatus from the communication apparatus. In some implementations, the RF signature associated with the dominant path of the first channel may be determined based on the first pilot signal. The network node may also determine one or more parameters of a beamformer based on the RF signature associated with the dominant path of the first channel.

In some implementations, the network node may further transmit a second pilot signal to the communication apparatus and receive at least one channel parameter associated with a second channel from the communication apparatus.

In some implementations, the RF signature associated with the dominant path of the first channel may comprise information regarding an angle of departure and a fading coefficient of the dominant path of the first channel.

In some implementations, the first pilot signal may comprise a non-beamformed pilot signal, and the first channel may comprise a non-beamformed channel.

In some implementations, the dominant path of the first channel may comprise a path between the network node and the communication apparatus (e.g., a path from the antenna array of the network node to the antenna array of the communication apparatus) with a received signal power greater than a predetermined threshold.

In some implementations, the second pilot signal may comprise a beamformed pilot signal generated by the beamformer and the second channel may comprise a beamformed channel, and the channel parameter may comprise an RF signature associated with a dominant path of the second channel.

In some implementations, the RF signature associated with the dominant path of the second channel may comprise information regarding an angle of departure, a fading coefficient and a delay of the dominant path of the second channel, and the dominant path of the second channel may comprise a path between an input of the beamformer of the network node and the communication apparatus (e.g., a path from the input of the beamformer of the network node to the communication apparatus) with a received signal power greater than a predetermined threshold.

In some implementations, the network node may further determine a covariance matrix of the second channel based on the RF signature associated with the dominant path of the second channel and determine one or more parameters of a precoder based on the covariance matrix of the second channel.

In some implementations, the network node may further transmit a downlink signal to the communication apparatus, and the downlink signal may be precoded by the precoder and beamformed by the beamformer.

In some implementations, the second pilot signal may comprise a beamformed pilot signal generated by a beamformer of the network node and the second channel may comprise a beamformed channel, and the channel parameter may comprise at least one of an RI and a PMI.

In some implementations, the network node may further determine one or more parameters of a precoder based on the channel parameter.

In some implementations, the network node may further transmit a downlink signal to the communication apparatus, and the downlink signal may be precoded by the precoder and beamformed by the beamformer.

### Illustrative Implementations

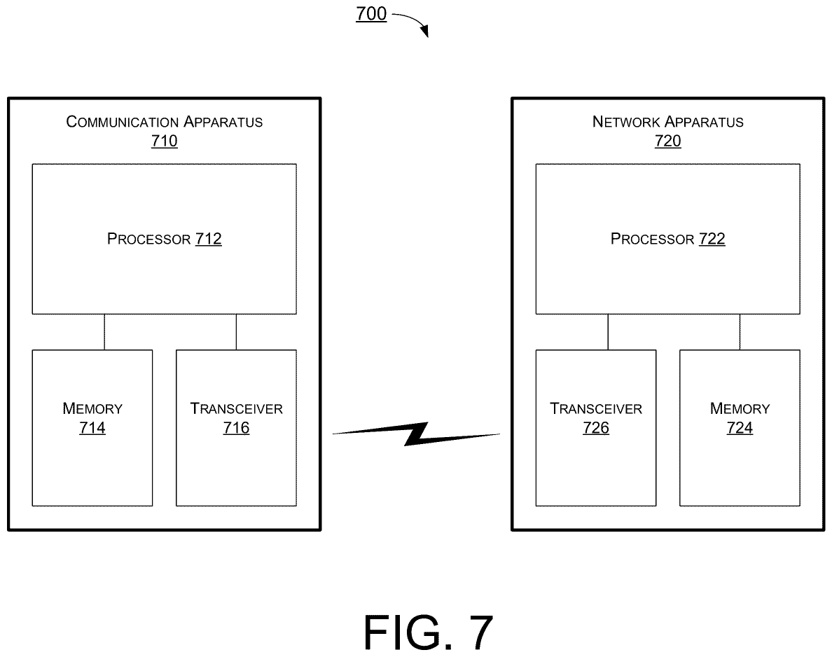

FIG. 7 illustrates an example communication system 700 having an example communication apparatus 710 and an example network apparatus 720 in accordance with an implementation of the present disclosure. Each of the communication apparatus 710 and the network apparatus 720 may perform various functions to implement schemes, techniques, processes and methods described herein pertaining to beam management with respect to user equipment and network apparatus in mobile communications, including scenarios/schemes described above as well as the processes 800, 900, 1000 and 1100 described below.

The communication apparatus 710 may be a part of an electronic apparatus, which may be a UE such as a portable or mobile apparatus, a wearable apparatus, a wireless communication apparatus or a computing apparatus. For instance, the communication apparatus 710 may be implemented in a smartphone, a smartwatch, a personal digital assistant, a digital camera, or a computing equipment such as a tablet computer, a laptop computer or a notebook computer. The communication apparatus 710 may also be a part of a machine type apparatus, which may be an IoT, NB-IoT, or IIoT apparatus such as an immobile or a stationary apparatus, a home apparatus, a wire communication apparatus or a computing apparatus. For instance, the communication apparatus 710 may be implemented in a smart thermostat, a smart fridge, a smart door lock, a wireless speaker or a home control center. Alternatively, the communication apparatus 710 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. The communication apparatus 710 may include at least some of those components shown in FIG. 7 such as a processor 712, for example. The communication apparatus 710 may further include one or more other components not pertinent to the proposed scheme of the present disclosure (e.g., internal power supply, display device and/or user interface device), and, thus, such component(s) of the communication apparatus 710 are neither shown in FIG. 7 nor described below in the interest of simplicity and brevity.

The network apparatus 720 may be a part of a network device, which may be a network node such as a satellite, a base station, a small cell, a router or a gateway. For instance, the network apparatus 720 may be implemented in an eNodeB in an LTE network, in a gNB in a 5G/NR, IoT, NB-IoT or IIoT network or in a satellite or base station in a 6G network. Alternatively, the network apparatus 720 may be implemented in the form of one or more IC chips such as, for example and without limitation, one or more single-core processors, one or more multi-core processors, or one or more RISC or CISC processors. The network apparatus 720 may include at least some of those components shown in FIG. 7 such as a processor 722, for example. The network apparatus 720 may further include one or more other components not pertinent to the proposed scheme of the present disclosure (e.g., internal power supply, display device and/or user interface device), and, thus, such component(s) of the network apparatus 720 are neither shown in FIG. 7 nor described below in the interest of simplicity and brevity.

In one aspect, each of the processor 712 and the processor 722 may be implemented in the form of one or more single-core processors, one or more multi-core processors, or one or more CISC processors. That is, even though a singular term “a processor” is used herein to refer to the processor 712 and the processor 722, each of the processor 712 and the processor 722 may include multiple processors in some implementations and a single processor in other implementations in accordance with the present disclosure. In another aspect, each of the processor 712 and the processor 722 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of the processor 712 and the processor 722 is a special-purpose machine specifically designed, arranged and configured to perform specific tasks including autonomous reliability enhancements in a device (e.g., as represented by the communication apparatus 710) and a network (e.g., as represented by the network apparatus 720) in accordance with various implementations of the present disclosure.

In some implementations, the communication apparatus 710 may also include a transceiver 716 coupled to the processor 712 and capable of wirelessly transmitting and receiving data. In some implementations, the communication apparatus 710 may have one or more antenna elements or physical antennas. In some implementations, the communication apparatus 710 may have at least one antenna array. In some implementations, the communication apparatus 710 may further include a memory 714 coupled to the processor 712 and capable of being accessed by the processor 712 and storing data therein. In some implementations, the network apparatus 720 may also include a transceiver 726 coupled to the processor 722 and capable of wirelessly transmitting and receiving data. In some implementations, the network apparatus 720 may have one or more antenna elements or physical antennas. In some implementations, the network apparatus 720 may have at least one antenna array. In some implementations, the network apparatus 720 may have a plurality of physical antennas which associates with a plurality of antenna ports. In some implementations, the network apparatus 720 may include a digital precoder (such as the digital precoder depicted in FIG. 1), one or more TXRU (such as the TXRUs depicted in FIG. 1) and a beamformer (such as the array beamformer depicted in FIG. 1).

In some implementations, the network apparatus 720 may further include a memory 724 coupled to processor 722 and capable of being accessed by the processor 722 and storing data therein. Accordingly, the communication apparatus 710 and the network apparatus 720 may wirelessly communicate with each other via the transceiver 716 and the transceiver 726, respectively. To aid better understanding, the following description of the operations, functionalities and capabilities of each of the communication apparatus 710 and the network apparatus 720 is provided in the context of a mobile communication environment in which the communication apparatus 710 is implemented in or as a communication apparatus or a UE and the network apparatus 720 is implemented in or as a network node or a network device of a communication network.

In some implementations, in the operations of beam management with respect to the communication apparatus 710 in the first aspect of the present disclosure, the processor 712 of the communication apparatus 710 may receive, via the transceiver 716, a pilot signal from a network node (e.g., the network apparatus 720) and determine an RF signature associated with a dominant path of a channel between the network apparatus 720 and communication apparatus 710 according to the pilot signal. In some implementations, the processor 712 may further report the RF signature associated with the dominant path of the channel to the network apparatus 720 via the transceiver 716.

In some implementations, the RF signature may comprise information regarding at least one of an angle of departure, a fading coefficient and a delay of the dominant path.

In some implementations, the pilot signal may comprise a non-beamformed pilot signal, and the channel may comprise a non-beamformed channel.

In some implementations, the processor 712 may further receive, via the transceiver 716, a downlink signal from the network apparatus 720. In some implementations, the downlink signal may be precoded by a precoder and beamformed by a beamformer of the network apparatus 720, and the RF signature may be used to determine one or more parameters of the precoder and one or more parameters of the beamformer.

In some implementations, the processor 712 may further transmit a reference signal to the network apparatus 720 and receive a downlink signal from the network apparatus 720 via the transceiver 716. In some implementations, the downlink signal may be precoded by a precoder and beamformed by a beamformer of the network apparatus 720, and the RF signature may be used to determine one or more parameters of the beamformer and the reference signal may be used to determine one or more parameters of the precoder.

In some implementations, the dominant path of the channel may comprise a path between the network apparatus 720 and the communication apparatus 710 (e.g., a path from the antenna array of the network apparatus 720 to the antenna array of the communication apparatus 710) with a received signal power greater than a predetermined threshold.

In some implementations, in the operations of beam management with respect to the communication apparatus 710 in the second aspect of the present disclosure, the processor 712 of the communication apparatus 710 may receive, via the transceiver 716, a first pilot signal from the network apparatus 720 and determine an RF signature associated with a dominant path of a first channel between the network apparatus 720 and the communication apparatus 710 according to the first pilot signal. The processor 712 may also report the RF signature associated with the dominant path of the first channel to the network apparatus 720 and receive a second pilot signal from the network apparatus 720 via the transceiver 716. The processor 712 may further determine at least one channel parameter associated with a second channel according to the second pilot signal and report, via the transceiver 716, the channel parameter associated with the second channel to the network apparatus 720.

In some implementations, the RF signature associated with the dominant path of the first channel may comprise information regarding an angle of departure and a fading coefficient of the dominant path of the first channel.

In some implementations, the first pilot signal may comprise a non-beamformed pilot signal, and the first channel may comprise a non-beamformed channel.

In some implementations, the dominant path of the first channel may comprise a path between the network apparatus 720 and the communication apparatus 710 (e.g., a path from the antenna array of the network apparatus 720 to the antenna array of the communication apparatus 710) with a received signal power greater than a predetermined threshold.

In some implementations, the second pilot signal may comprise a beamformed pilot signal generated by a beamformer of the network apparatus 720, and the RF signature associated with the dominant path of the first channel may be used to determine one or more parameters of the beamformer.

In some implementations, the channel parameter may comprise an RF signature associated with a dominant path of the second channel, and the second channel may comprise a beamformed channel.

In some implementations, the processor 712 may receive, via the transceiver 716, a downlink signal from the network apparatus 720. In some implementations, the downlink signal may be precoded by a precoder and beamformed by the beamformer of the network apparatus 720, and the RF signature associated with the dominant path of the second channel may be used to determine one or more parameters of the precoder.

In some implementations, the second pilot signal may comprise a beamformed pilot signal generated by a beamformer of the network apparatus 720 and the second channel may comprise a beamformed channel. In some implementations, the channel parameter may comprise at least one of an RI and a PMI.

In some implementations, the processor 712 may receive, via the transceiver 716, a downlink signal from the network apparatus 720. In some implementations, the downlink signal may be precoded by a precoder and beamformed by the beamformer of the network apparatus 720, and the channel parameter may be used to determine one or more parameters of the precoder.

In some implementations, in the operations of beam management with respect to the network apparatus 720 in the first aspect of the present disclosure, the processor 722 of the network apparatus 720 may receive, via the transceiver 726, an RF signature associated with a dominant path of a first channel between the network apparatus 720 and a communication apparatus from the communication apparatus (e.g., the communication apparatus 710), and determine one or more parameters of a beamformer based on the RF signature associated with the dominant path of the first channel.

In some implementations, the RF signature associated with the dominant path of the first channel may comprise information regarding an angle of departure and a fading coefficient of the dominant path of the first channel.

In some implementations, the RF signature associated with the dominant path of the first channel may further comprise information regarding a delay of the dominant path of the first channel.

In some implementations, the dominant path of the first channel may comprise a path between the network apparatus 720 and the communication apparatus 710 (e.g., a path from the antenna array of the network apparatus 720 to the antenna array of the communication apparatus 710) with a received signal power greater than a predetermined threshold.

In some implementations, in the determining of the one or more parameters of the beamformer, the processor 722 may determine a covariance matrix of the first channel based on the RF signature associated with the dominant path of the first channel and determine the one or more parameters of the beamformer based on the covariance matrix of the first channel.

In some implementations, the processor 722 may further determine a covariance matrix of a second channel between the network apparatus 720 and the communication apparatus 710 based on the covariance matrix of the first channel and the one or more parameters of the beamformer or based on the RF signature associated with the dominant path of the first channel and the one or more parameters of the beamformer, and determine one or more parameters of a precoder based on the covariance matrix of the second channel.

In some implementations, the processor 722 may receive, via the transceiver 726, a reference signal from the communication apparatus 710 and determine an RF signature associated with a dominant path of a second channel between the communication apparatus 710 and the network apparatus 720 according to the reference signal. In some implementations, the first channel may comprise a non-beamformed channel and the second channel may comprise a beamformed channel.

In some implementations, the processor 722 may determine a covariance matrix of the second channel based on the RF signature associated with the dominant path of the second channel and channel reciprocity, and determine one or more parameters of a precoder based on the covariance matrix of the second channel.

In some implementations, the RF signature associated with the dominant path of the second channel may comprise information regarding an angle of departure, a fading coefficient and a delay of the dominant path of the second channel, and the dominant path of the second channel may comprise a path between the beamformer of the network apparatus 720 and the communication apparatus 710 with a received signal power greater than a predetermined threshold.

In some implementations, the dominant path of the second channel may comprise a path from an input of the beamformer of the network apparatus 720 to the communication apparatus 710 with a received signal power greater than a predetermined threshold and/or comprise a path from the communication apparatus 710 to the beamformer of the network apparatus 720 with a received signal power greater than a predetermined threshold.

In some implementations, the processor 722 may transmit, via the transceiver 726, a pilot signal to the communication apparatus 710. In some implementations, the pilot signal may comprise a non-beamformed pilot signal and the RF signature associated with the dominant path of the first channel may be determined based on the pilot signal.

In some implementations, in the operations of beam management with respect to the network apparatus 720 in the second aspect of the present disclosure, the processor 722 of the network apparatus 720 may transmit a first pilot signal to a communication apparatus (e.g., the communication apparatus 710) and receive an RF signature associated with a dominant path of a first channel between the network apparatus 720 and the communication apparatus 710 from the communication apparatus 710 via the transceiver 726. In some implementations, the RF signature associated with the dominant path of the first channel may be determined based on the first pilot signal. The processor 722 may also determine one or more parameters of a beamformer based on the RF signature associated with the dominant path of the first channel.

The processor 722 may further transmit, via the transceiver 726, a second pilot signal to the communication apparatus 710, and receive, via the transceiver 726, at least one channel parameter associated with a second channel from the communication apparatus 710.

In some implementations, the RF signature associated with the dominant path of the first channel may comprise information regarding an angle of departure and a fading coefficient of the dominant path of the first channel.

In some implementations, the first pilot signal may comprise a non-beamformed pilot signal, and the first channel may comprise a non-beamformed channel.

In some implementations, the dominant path of the first channel may comprise a path between the network apparatus 720 and the communication apparatus 710 (e.g., a path from the antenna array of the network apparatus 720 to the antenna array of the communication apparatus 710) with a received signal power greater than a predetermined threshold.

In some implementations, the second pilot signal may comprise a beamformed pilot signal generated by the beamformer and the second channel may comprise a beamformed channel, and the channel parameter may comprise an RF signature associated with a dominant path of the second channel.

In some implementations, the RF signature associated with the dominant path of the second channel may comprise information regarding an angle of departure, a fading coefficient and a delay of the dominant path of the second channel, and the dominant path of the second channel may comprise a path between an input of the beamformer of the network apparatus 720 and the communication apparatus 710 (e.g., a path from an input of the beamformer of the network apparatus 720 to the communication apparatus 710) with a received signal power greater than a predetermined threshold.

In some implementations, the processor 722 may further determine a covariance matrix of the second channel based on the RF signature associated with the dominant path of the second channel and determine one or more parameters of a precoder based on the covariance matrix of the second channel.

In some implementations, the processor 722 may further transmit, via the transceiver 726, a downlink signal to the communication apparatus 710, and the downlink signal may be precoded by the precoder and beamformed by the beamformer.

In some implementations, the second pilot signal may comprise a beamformed pilot signal generated by a beamformer of the network apparatus 720 and the second channel may comprise a beamformed channel, and the channel parameter may comprise at least one of an RI and a PMI.

In some implementations, the processor 722 may further determine one or more parameters of a precoder based on the channel parameter.

In some implementations, the processor 722 may further transmit, via the transceiver 726, a downlink signal to the communication apparatus 710, and the downlink signal may be precoded by the precoder and beamformed by the beamformer.

### Illustrative Processes

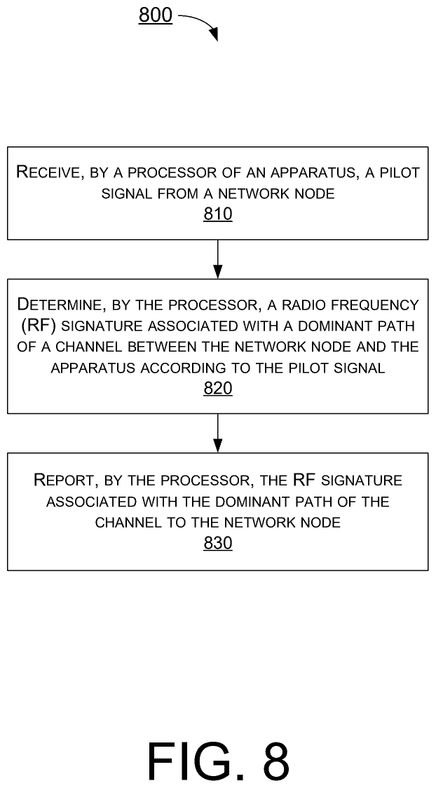

FIG. 8 illustrates an example process 800 in accordance with an implementation of the present disclosure. The process 800 may be an example implementation of above scenarios/schemes, whether partially or completely, with respect to a procedure of determining beamforming parameters for beam management in accordance with the present disclosure. The process 800 may represent an aspect of implementation of features of the communication apparatus 710. The process 800 may include one or more operations, actions, or functions as illustrated by one or more of blocks 810, 820 and 830. Although illustrated as discrete blocks, various blocks of the process 800 may be divided into additional blocks, combined into fewer blocks, or eliminated, depending on the desired implementation. Moreover, the blocks of the process 800 may be executed in the order shown in FIG. 8 or, alternatively, in a different order. The process 800 may be implemented by the communication apparatus 710 or any suitable UE or machine type devices. Solely for illustrative purposes and without limitation, the process 800 is described below in the context of the communication apparatus 710. The process 800 may begin at block 810.

At 810, the process 800 may involve the processor 712 of the communication apparatus 710 receiving a pilot signal from a network node (e.g., the network apparatus 720). The process 800 may proceed from 810 to 820.

At 820, the process 800 may involve the processor 712 determining an RF signature associated with a dominant path of a channel between the network node and the communication apparatus 710 according to the pilot signal. The process 800 may proceed from 820 to 830.

At 830, the process 800 may involve the processor 712 reporting the RF signature associated with the dominant path of the channel to the network node.

In some implementations, the RF signature may comprise information regarding an angle of departure and a fading coefficient of the dominant path.

In some implementations, the RF signature may further comprise information regarding a delay of the dominant path.

In some implementations, the pilot signal may comprise a non-beamformed pilot signal, and the channel may comprise a non-beamformed channel.

In some implementations, the dominant path of the channel may comprise a path between the network node and the communication apparatus 710 (e.g., a path from the antenna array of the network node to the antenna array of the communication apparatus 710) with a received signal power greater than a predetermined threshold.

In some implementations, the process 800 may further involve the processor 712 receiving a downlink signal from the network node. In some implementations, the downlink signal may be precoded by a precoder and beamformed by a beamformer of the network node, and the RF signature may be used to determine one or more parameters of the precoder and one or more parameters of the beamformer.

In some implementations, the process 800 may further involve the processor 712 transmitting a reference signal to the network node and receiving a downlink signal from the network node. In some implementations, the downlink signal may be precoded by a precoder and beamformed by a beamformer of the network node, and the RF signature may be used to determine one or more parameters of the beamformer and the reference signal may be used to determine one or more parameters of the precoder.

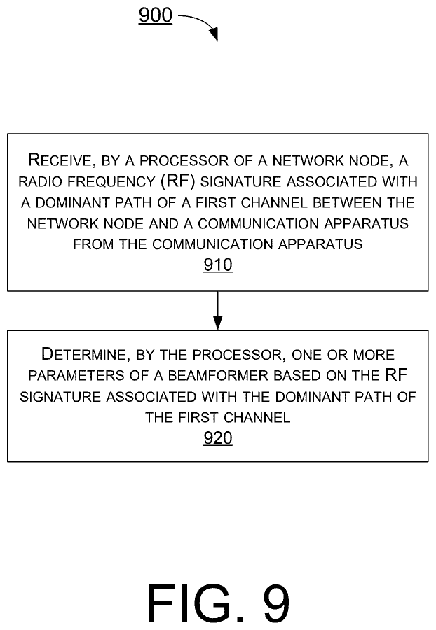

FIG. 9 depicting an example process 900 in accordance with an implementation of the present disclosure. The process 900 may be an example implementation of above scenarios/schemes, whether partially or completely, with respect to a procedure of determining beamforming parameters for beam management in accordance with the present disclosure. The process 900 may represent an aspect of implementation of features of the network apparatus 720. The process 900 may include one or more operations, actions, or functions as illustrated by one or more of blocks 910 and 920. Although illustrated as discrete blocks, various blocks of the process 900 may be divided into additional blocks, combined into fewer blocks, or eliminated, depending on the desired implementation. Moreover, the blocks of the process 900 may be executed in the order shown in FIG. 9 or, alternatively, in a different order. The process 900 may be implemented by the network apparatus 720 or any suitable network device or network node. Solely for illustrative purposes and without limitation, the process 900 is described below in the context of the network apparatus 720. The process 900 may begin at block 910.

At 910, the process 900 may involve the processor 722 of the network apparatus 720 receiving an RF signature associated with a dominant path of a first channel between the network apparatus 720 and a communication apparatus from the communication apparatus (e.g., the communication apparatus 710). The process 900 may proceed from 910 to 920.

At 920, the process 900 may involve the processor 722 determining one or more parameters of a beamformer based on the RF signature associated with the dominant path of the first channel.

In some implementations, the RF signature associated with the dominant path of the first channel may comprise information regarding an angle of departure and a fading coefficient of the dominant path of the first channel.

In some implementations, the RF signature associated with the dominant path of the first channel may further comprise information regarding a delay of the dominant path of the first channel.

In some implementations, the dominant path of the first channel may comprise a path between the network apparatus 720 and the communication apparatus (e.g., a path from the antenna array of the network apparatus 720 to the antenna array of the communication apparatus) with a received signal power greater than a predetermined threshold.

In some implementations, in the determining of the one or more parameters of the beamformer, the process 900 may further involve the processor 722 determining a covariance matrix of the first channel based on the RF signature associated with the dominant path of the first channel and determining the one or more parameters of the beamformer based on the covariance matrix of the first channel.

In some implementations, the process 900 may further involve the processor 722 determining a covariance matrix of a second channel between the network apparatus 720 and the communication apparatus based on the covariance matrix of the first channel and the one or more parameters of the beamformer or based on the RF signature associated with the dominant path of the first channel and the one or more parameters of the beamformer, and determining one or more parameters of a precoder based on the covariance matrix of the second channel.

In some implementations, the process 900 may further involve the processor 722 receiving a reference signal from the communication apparatus and determining an RF signature associated with a dominant path of a second channel between the communication apparatus and the network apparatus 720 according to the reference signal.

In some implementations, the first channel may comprise a non-beamformed channel and the second channel may comprise a beamformed channel.

In some implementations, the process 900 may further involve the processor 722 determining a covariance matrix of the second channel based on the RF signature associated with the dominant path of the second channel and channel reciprocity, and determining one or more parameters of a precoder based on the covariance matrix of the second channel.

In some implementations, the RF signature associated with the dominant path of the second channel may comprise information regarding an angle of departure, a fading coefficient and a delay of the dominant path of the second channel, and the dominant path of the second channel may comprise a path between the input of the beamformer of the network apparatus 720 and the communication apparatus with a received signal power greater than a predetermined threshold.

In some implementations, the dominant path of the second channel may comprise a path from an input of the beamformer of the network apparatus 720 to the communication apparatus with a received signal power greater than a predetermined threshold and/or comprise a path from the communication apparatus to the beamformer of the network apparatus 720 with a received signal power greater than a predetermined threshold.

In some implementations, the process 900 may further involve the processor 722 transmitting a pilot signal to the communication apparatus. In some implementations, the pilot signal may comprise a non-beamformed pilot signal and the RF signature associated with the dominant path of the first channel may be determined based on the pilot signal.

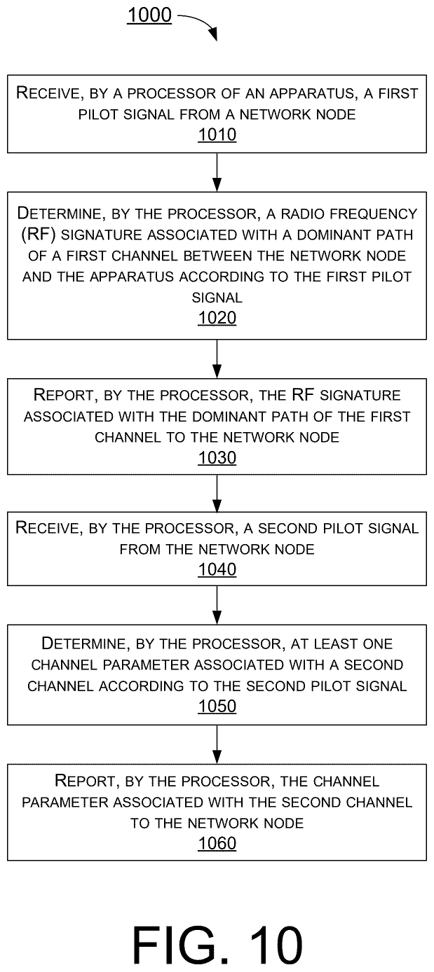

FIG. 10 illustrates an example process 1000 in accordance with an implementation of the present disclosure. The process 1000 may be an example implementation of above scenarios/schemes, whether partially or completely, with respect to a procedure of determining beamforming parameters for beam management in accordance with the present disclosure. The process 1000 may represent an aspect of implementation of features of the communication apparatus 710. The process 1000 may include one or more operations, actions, or functions as illustrated by one or more of blocks 1010, 1020, 1030, 1040, 1050 and 1060. Although illustrated as discrete blocks, various blocks of the process 1000 may be divided into additional blocks, combined into fewer blocks, or eliminated, depending on the desired implementation. Moreover, the blocks of the process 1000 may be executed in the order shown in FIG. 10 or, alternatively, in a different order. The process 1000 may be implemented by the communication apparatus 710 or any suitable UE or machine type devices. Solely for illustrative purposes and without limitation, the process 1000 is described below in the context of the communication apparatus 710. The process 1000 may begin at block 1010.

At 1010, the process 1000 may involve the processor 712 of the communication apparatus 710 receiving a first pilot signal from a network node (e.g., the network apparatus 720). The process 1000 may proceed from 1010 to 1020.

At 1020, the process 1000 may involve the processor 712 determining an RF signature associated with a dominant path of a first channel between the network node and the communication apparatus 710 according to the first pilot signal. The process 1000 may proceed from 1020 to 1030.

At 1030, the process 1000 may involve the processor 712 reporting the RF signature associated with the dominant path of the first channel to the network node. The process 1000 may proceed from 1030 to 1040.

At 1040, the process 1000 may involve the processor 712 of the communication apparatus 710 receiving a second pilot signal from the network node. The process 1000 may proceed from 1040 to 1050.

At 1050, the process 1000 may involve the processor 712 determining at least one channel parameter associated with a second channel according to the second pilot signal. The process 1000 may proceed from 1050 to 1060.

At 1060, the process 1000 may involve the processor 712 reporting the channel parameter associated with the second channel to the network node.

In some implementations, the RF signature associated with the dominant path of the first channel may comprise information regarding an angle of departure and a fading coefficient of the dominant path of the first channel.

In some implementations, the first pilot signal may comprise a non-beamformed pilot signal, and the first channel may comprise a non-beamformed channel.

In some implementations, the dominant path of the first channel may comprise a path between the network node and the communication apparatus 710 (e.g., a path from the antenna array of the network node to the antenna array of the communication apparatus 710) with a received signal power greater than a predetermined threshold.

In some implementations, the second pilot signal may comprise a beamformed pilot signal generated by a beamformer of the network node, and the RF signature associated with the dominant path of the first channel may be used to determine one or more parameters of the beamformer.

In some implementations, the channel parameter may comprise an RF signature associated with a dominant path of the second channel, and the second channel may comprise a beamformed channel.

In some implementations, the process 1000 may involve the processor 712 receiving a downlink signal from the network node. In some implementations, the downlink signal may be precoded by a precoder and beamformed by the beamformer of the network node and the RF signature associated with the dominant path of the second channel may be used to determine one or more parameters of the precoder.

In some implementations, the second pilot signal may comprise a beamformed pilot signal generated by a beamformer of the network node and the second channel may comprise a beamformed channel. In some implementations, the channel parameter may comprise at least one of an RI and a PMI.

In some implementations the process 1000 may involve the processor 712 receiving a downlink signal from the network node. In some implementations, the downlink signal may be precoded by a precoder and beamformed by the beamformer of the network node and the channel parameter may be used to determine one or more parameters of the precoder.

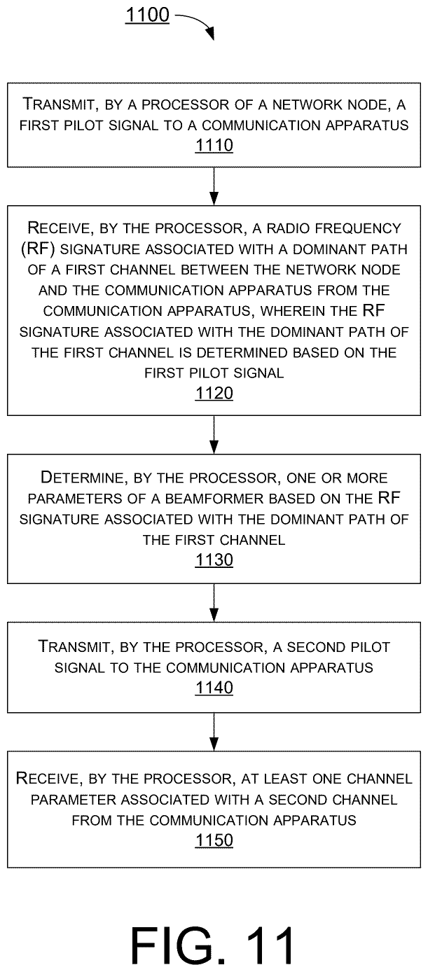

FIG. 11 depicting an example process 1100 in accordance with an implementation of the present disclosure. The process 1100 may be an example implementation of above scenarios/schemes, whether partially or completely, with respect to a procedure of determining beamforming parameters for beam management in accordance with the present disclosure. The process 1100 may represent an aspect of implementation of features of the network apparatus 720. The process 1100 may include one or more operations, actions, or functions as illustrated by one or more of blocks 1110, 1120, 1130, 1140 and 1150. Although illustrated as discrete blocks, various blocks of the process 1100 may be divided into additional blocks, combined into fewer blocks, or eliminated, depending on the desired implementation. Moreover, the blocks of the process 1100 may be executed in the order shown in FIG. 11 or, alternatively, in a different order. The process 1100 may be implemented by the network apparatus 720 or any suitable network device or network node. Solely for illustrative purposes and without limitation, the process 1100 is described below in the context of the network apparatus 720. The process 1100 may begin at block 1110.

At 1110, the process 1100 may involve the processor 722 of the network apparatus 720 transmitting a first pilot signal to a communication apparatus (e.g., the communication apparatus 710). The process 1100 may proceed from 1110 to 1120.

At 1120, the process 1100 may involve the processor 722 receiving an RF signature associated with a dominant path of a first channel between the network apparatus 720 and the communication apparatus from the communication apparatus, wherein the RF signature associated with the dominant path of the first channel is determined based on the first pilot signal. The process 1100 may proceed from 1120 to 1130.

At 1130, the process 1100 may involve the processor 722 determining one or more parameters of a beamformer based on the RF signature associated with the dominant path of the first channel. The process 1100 may proceed from 1130 to 1140.

At 1140, the process 1100 may involve the processor 722 transmitting a second pilot signal to the communication apparatus. The process 1100 may proceed from 1140 to 1150.

At 1150, the process 1100 may involve the processor 722 receiving at least one channel parameter associated with a second channel from the communication apparatus.

In some implementations, the RF signature associated with the dominant path of the first channel may comprise information regarding an angle of departure and a fading coefficient of the dominant path of the first channel.

In some implementations, the first pilot signal may comprise a non-beamformed pilot signal, and the first channel may comprise a non-beamformed channel.

In some implementations, the dominant path of the first channel may comprise a path between the network apparatus 720 and the communication apparatus (e.g., a path from the antenna array of the network apparatus 720 to the antenna array of the communication apparatus) with a received signal power greater than a predetermined threshold.

In some implementations, the second pilot signal may comprise a beamformed pilot signal generated by the beamformer and the second channel may comprise a beamformed channel, and the channel parameter may comprise an RF signature associated with a dominant path of the second channel.

In some implementations, the RF signature associated with the dominant path of the second channel may comprise information regarding an angle of departure, a fading coefficient and a delay of the dominant path of the second channel, and the dominant path of the second channel may comprise a path between an input of the beamformer of the network apparatus 720 and the communication apparatus (e.g., a path from an input of the beamformer of the network apparatus 720 to the communication apparatus) with a received signal power greater than a predetermined threshold.

In some implementations, the process 1100 may further involve the processor 722 determining a covariance matrix of the second channel based on the RF signature associated with the dominant path of the second channel and determining one or more parameters of a precoder based on the covariance matrix of the second channel.

In some implementations, the process 1100 may further involve the processor 722 transmitting a downlink signal to the communication apparatus, and the downlink signal may be precoded by the precoder and beamformed by the beamformer.

In some implementations, the second pilot signal may comprise a beamformed pilot signal generated by a beamformer of the network apparatus 720 and the second channel may comprise a beamformed channel, and the channel parameter may comprise at least one of an RI and a PMI.

In some implementations, the process 1100 may further involve the processor 722 determining one or more parameters of a precoder based on the channel parameter.

In some implementations, the process 1100 may further involve the processor 722 transmitting a downlink signal to the communication apparatus, and the downlink signal may be precoded by the precoder and beamformed by the beamformer.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a first pilot signal from a network node;
determining, by the processor, a radio frequency (RF) signature associated with a dominant path of a first channel between the network node and the apparatus according to the first pilot signal;
reporting, by the processor, the RF signature associated with the dominant path of the first channel to the network node;
receiving, by the processor, a second pilot signal from the network node;
determining, by the processor, at least one channel parameter associated with a second channel according to the second pilot signal; and
reporting, by the processor, the channel parameter associated with the second channel to the network node.

2. The method of claim 1, wherein the RF signature associated with the dominant path of the first channel comprises information regarding an angle of departure and a fading coefficient of the dominant path of the first channel.

3. The method of claim 1, wherein the first pilot signal comprises a non-beamformed pilot signal, and wherein the first channel comprises a non-beamformed channel.

4. The method of claim 1, wherein the dominant path of the first channel comprises a path between the network node and the apparatus with a received signal power greater than a predetermined threshold.

5. The method of claim 1, wherein the second pilot signal comprises a beamformed pilot signal generated by a beamformer of the network node, and wherein the RF signature associated with the dominant path of the first channel is used to determine one or more parameters of the beamformer.

6. The method of claim 1, wherein the channel parameter comprises an RF signature associated with a dominant path of the second channel, and wherein the second channel comprises a beamformed channel.

7. The method of claim 6, further comprising:
receiving, by the processor, a downlink signal from the network node,
wherein the downlink signal is precoded by a precoder and beamformed by the beamformer of the network node, and
wherein the RF signature associated with the dominant path of the second channel is used to determine one or more parameters of the precoder.

8. The method of claim 1, wherein the second pilot signal comprises a beamformed pilot signal generated by a beamformer of the network node and the second channel comprises a beamformed channel, and wherein the channel parameter comprises at least one of a rank indicator and a precoding matrix indicator.

9. The method of claim 8, further comprising:
receiving, by the processor, a downlink signal from the network node,
wherein the downlink signal is precoded by a precoder and beamformed by the beamformer of the network node, and
wherein the channel parameter is used to determine one or more parameters of the precoder.

10. A method, comprising:
transmitting, by a processor of a network node, a first pilot signal to a communication apparatus;
receiving, by the processor, a radio frequency (RF) signature associated with a dominant path of a first channel between the network node and the communication apparatus from the communication apparatus, wherein the RF signature associated with the dominant path of the first channel is determined based on the first pilot signal;
determining, by the processor, one or more parameters of a beamformer based on the RF signature associated with the dominant path of the first channel;
transmitting, by the processor, a second pilot signal to the communication apparatus; and
receiving, by the processor, at least one channel parameter associated with a second channel from the communication apparatus.

11. The method of claim 10, wherein the RF signature associated with the dominant path of the first channel comprises information regarding an angle of departure and a fading coefficient of the dominant path of the first channel.

12. The method of claim 10, wherein the first pilot signal comprises a non-beamformed pilot signal, and wherein the first channel comprises a non-beamformed channel.

13. The method of claim 10, wherein the dominant path of the first channel comprises a path between the network node and the communication apparatus with a received signal power greater than a predetermined threshold.

14. The method of claim 10, wherein the second pilot signal comprises a beamformed pilot signal generated by the beamformer and the second channel comprises a beamformed channel, and wherein the channel parameter comprises an RF signature associated with a dominant path of the second channel.

15. The method of claim 14, wherein the RF signature associated with the dominant path of the second channel comprises information regarding an angle of departure, a fading coefficient and a delay of the dominant path of the second channel, and wherein the dominant path of the second channel comprises a path between an input of the beamformer of the network node and the communication apparatus with a received signal power greater than a predetermined threshold.

16. The method of claim 14, further comprising:
determining, by the processor, a covariance matrix of the second channel based on the RF signature associated with the dominant path of the second channel; and
determining, by the processor, one or more parameters of a precoder based on the covariance matrix of the second channel.

17. The method of claim 16, further comprising:
transmitting, by the processor, a downlink signal to the communication apparatus,
wherein the downlink signal is precoded by the precoder and beamformed by the beamformer.

18. The method of claim 10, wherein the second pilot signal comprises a beamformed pilot signal generated by a beamformer of the network node and the second channel comprises a beamformed channel, and wherein the channel parameter comprises at least one of a rank indicator and a precoding matrix indicator.

19. The method of claim 18, further comprising:
determining, by the processor, one or more parameters of a precoder based on the channel parameter.

20. The method of claim 19, further comprising:
transmitting, by the processor, a downlink signal to the communication apparatus,
wherein the downlink signal is precoded by the precoder and beamformed by the beamformer.
